(19) United States
(12) Patent Application Publication
(10) Pub. No.: US 2012/0139902 A1
(43) Pub. Date: Jun. 7, 2012

(54) PARALLAX IMAGE GENERATING APPARATUS, STEREOSCOPIC PICTURE DISPLAYING APPARATUS AND PARALLAX IMAGE GENERATION METHOD

(76) Inventors: Tatsuro Fujisawa, Tokyo (JP); Tse Kai Heng, Tokyo (JP)

(21) Appl. No.: 13/162,227

(22) Filed: Jun. 16, 2011

(30) Foreign Application Priority Data
Dec. 3, 2010 (JP) 2010-270556

(51) Int. Cl. G06T 15/00

(52) U.S. Cl. 345/419

(57) ABSTRACT

An embodiment provides a parallax image generating apparatus including a disparity generating section, a disparity correcting section and an image shifting section. The disparity generating section is configured to receive a depth of each part of an input image, and based on the depth, generate a disparity for the part of the image for a respective viewpoint. The disparity correcting section is configured to correct a disparity of a target part of the image to a value based on a disparity obtained for a foreground part from among parts neighboring the target part. The image shifting section is configured to move a part of the input image based on the disparity corrected by the disparity correcting section, to generate a parallax image for the respective viewpoint.

### CROSS-REFERENCE TO RELATED ED APPLICATION

This application is based upon and claims the benefit of priority from Japanese Patent Application No. 2010-270556, filed on Dec. 3, 2010, the entire contents of which are incorporated herein by reference.

### FIELD

Embodiments described herein generally relate to a parallax image generating apparatus, a stereoscopic picture displaying apparatus and a parallax image generation method.

### BACKGROUND

In recent years, in response to the demand for enhancement in the quality of images, stereoscopic processing techniques have largely been studied. For stereoscopic processing methods, there are various types of methods including, e.g., stereo methods and light-section methods. These methods have both drawbacks and advantages, and a method to be employed is selected according to, e.g., the use of the images. However, any of the methods requires an expensive and large-size input apparatus in order to obtain three-dimensional images (3D images).

Meanwhile, as a method for performing stereoscopic processing using a simple circuit, a method in which no 3D image is used but a 3D image is generated from a two-dimensional image (2D image) has been provided. As a method employed for the aforementioned conversion from a 2D image to a stereo 3D image, and conversion from a two-viewpoint stereo 3D image to a multi-viewpoint 3D image, a method in which depth of input images are estimated has been provided. Various methods have been developed for techniques for obtaining the depth.

In a display apparatus in which the aforementioned image conversion is performed, a depth of each input image is estimated, and the depth is converted into a disparity, which is a horizontal shift amount, according to a viewpoint. The display apparatus generates a parallax image for the viewpoint by shifting the image according to the obtained disparity. For example, the display apparatus provides a parallax image for a viewpoint of a right eye (hereinafter referred to as “right image”) and a parallax image for a viewpoint of a left eye (hereinafter referred to as “left image”) to the right and left eyes, respectively, enabling stereoscopic display provided by the left and right images.

Where a depth is obtained for each of pixels or objects in an image and the pixel or the object is moved according to the disparity, the movement amounts of the pixel or the objects vary depending on the respective depths (disparities), which may result in pixels in different areas being moved so as to overlap in a same area, or pixels being moved so as to cause an area in which no image information exists (hereinafter referred to as “hidden surface area”).

Therefore, the display apparatus performs interpolation processing for the hidden surface area. In the interpolation processing, image quality deterioration may occur.

### BRIEF DESCRIPTION OF THE DRAWINGS

FIG. 1 is a block diagram illustrating a stereoscopic picture displaying apparatus according to a first embodiment;

FIG. 2 is a block diagram illustrating a specific configuration of a stereoscopic picture generating section 13 in FIG. 1;

FIG. 3 is a block diagram illustrating a specific configuration of a parallax image generating section 22 in FIG. 2;

FIG. 4 is a diagram illustrating a method for obtaining disparities in the parallax image generating section 22;

FIGS. 5A to 5C are diagrams illustrating a method for obtaining disparities in the parallax image generating section 22;

FIG. 6 is a diagram illustrating correction performed by a disparity correcting section 26;

FIG. 7 is a diagram illustrating correction performed by the disparity correcting section 26;

FIG. 8 is a diagram illustrating correction performed by the disparity correcting section 26;

FIG. 9 is a diagram illustrating correction performed by the disparity correcting section 26;

FIG. 10 is a diagram illustrating correction performed by the disparity correcting section 26;

FIG. 11 is a diagram illustrating correction performed by the disparity correcting section 26;

FIG. 12 is a flowchart illustrating an operation of the first embodiment;

FIG. 13 is a diagram illustrating an operation of the first embodiment;

FIG. 14 is a flowchart illustrating an operation of the first embodiment;

FIG. 15 is a diagram illustrating an operation of the first embodiment;

FIG. 16 is a flowchart illustrating a second embodiment;

FIG. 17 is a flowchart illustrating the second embodiment;

FIG. 18 is a diagram illustrating the second embodiment;

FIG. 19 is a flowchart illustrating a third embodiment; and

FIG. 20 is a flowchart illustrating the third embodiment.

### DETAILED DESCRIPTION

An embodiment provides a parallax image generating apparatus including a disparity generating section, a disparity correcting section and an image shifting section. The disparity generating section is configured to receive a depth of each part of an input image, and based on the depth, generate a disparity for the part of the image for a respective viewpoint. The disparity correcting section is configured to correct a disparity of a target part of the image to a value based on a disparity obtained for a foreground part from among parts neighboring the target part. The image shifting section is configured to move a part of the input image based on the disparity corrected by the disparity correcting section, to generate a parallax image for the respective viewpoint.

Hereinafter, embodiments will be described in details with reference to the drawings.

### First Embodiment

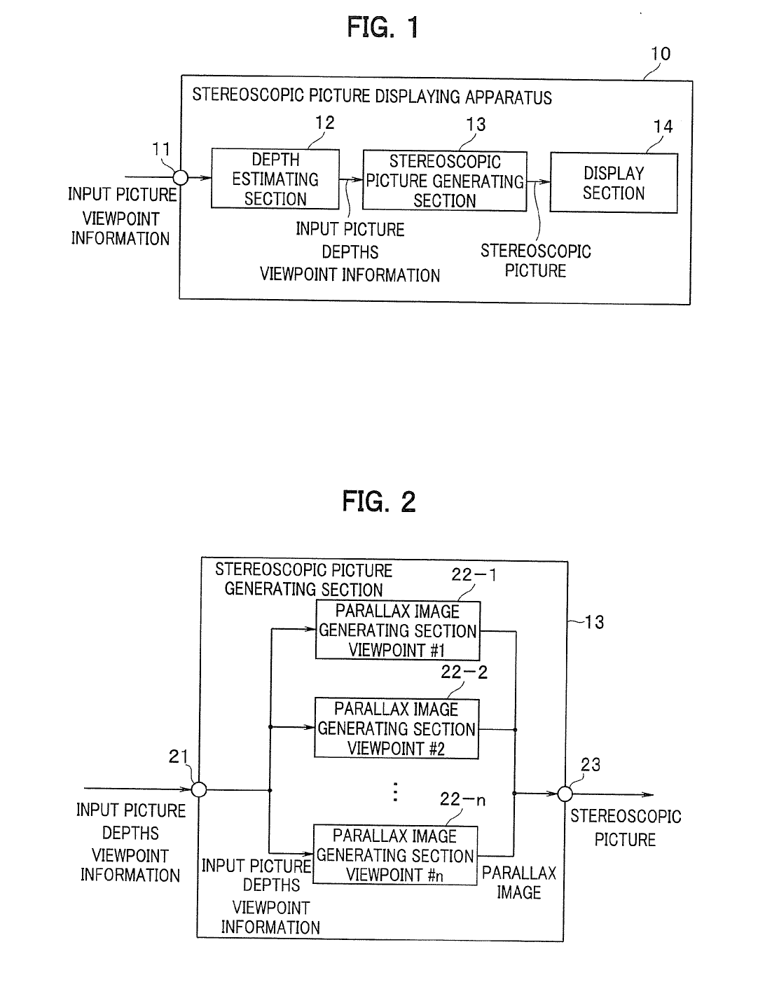

FIG. 1 is a block diagram illustrating a stereoscopic picture displaying apparatus according to a first embodiment.

An input picture and viewpoint information are input to an input terminal 11 of a stereoscopic picture displaying apparatus 10. The input picture is provided to a depth estimating section 12. The depth estimating section 12 estimates a depth for a predetermined area of each image in the input picture, using a known depth estimation method. For example, the depth estimating section 12 obtains a depth for each pixel or each object based on, e.g., the composition of the entire screen of the image, detection of a person or detection of movement for the object. The depth estimating section 12 outputs the input picture, the depths and the viewpoint information to a stereoscopic picture generating section 13.

FIG. 2 is a block diagram illustrating a specific configuration of the stereoscopic picture generating section 13 in FIG. 1.

The stereoscopic picture generating section 13 includes n parallax image generating sections 22-1 to 22-n (represented by a parallax image generating section 22 below). The parallax image generating sections 22-1 to 22-n receive the input picture, the depths and the viewpoint information via an input terminal 21, and generate parallax images for viewpoints #1 to #n, respectively. The stereoscopic picture generating section 13 combines the parallax images for the viewpoints #1 to #n generated by the parallax image generating sections 22-1 to 22-n to generate a multi-viewpoint image (stereoscopic picture) and outputs the multi-viewpoint image to a display section 14 via an output terminal 23.

The display section 14 is configured to be capable of displaying a multi-viewpoint image. For example, for the display section 14, a display section employing a parallax division method such as a parallax barrier method or a lenticular method can be employed.

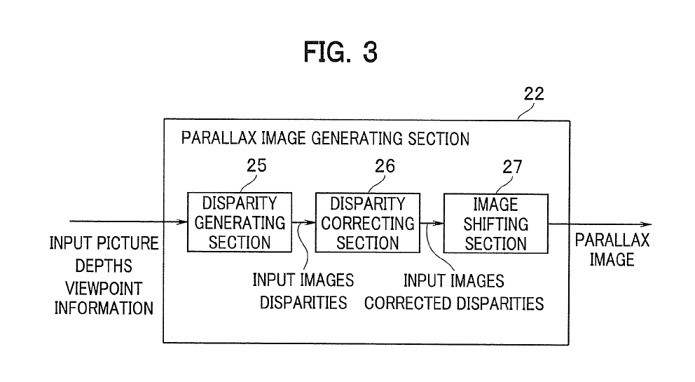

FIG. 3 is a block diagram illustrating a specific configuration of a parallax image generating section 22 in FIG. 2.

The parallax image generating sections 22-1 to 22-n in FIG. 2 have configurations that are mutually the same: a parallax image generating section 22 receives an input picture, depths and viewpoint information. A disparity generating section 25 in the parallax image generating section 22 converts the depth of each input image into a disparity, which is a horizontal shift amount, according to the viewpoint information. As described above, a disparity for a respective viewpoint is obtained by the disparity generating section 25 for, e.g., each pixel.

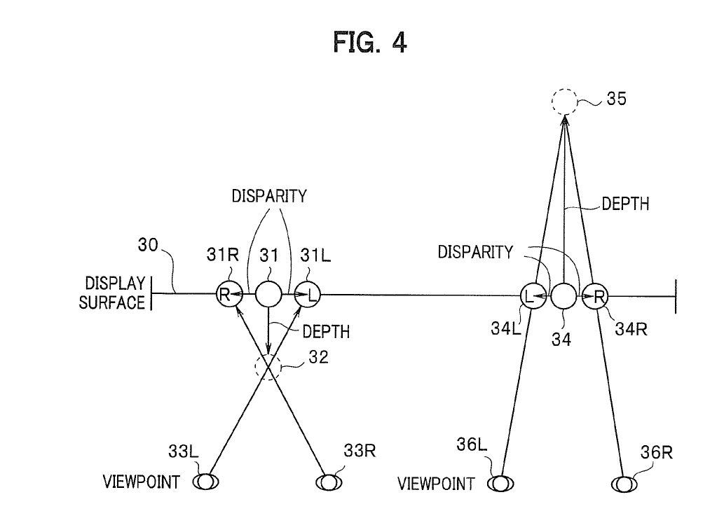

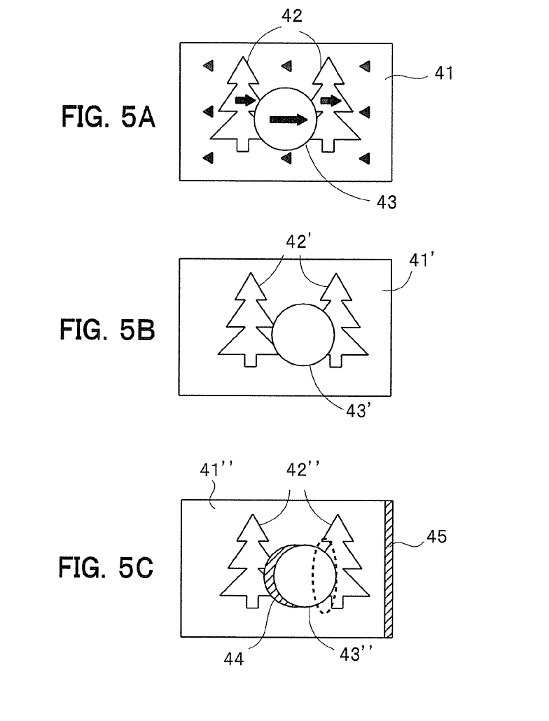

FIGS. 4 and 5A to 5C are diagrams illustrating a method for obtaining disparities in the parallax image generating section 22. FIG. 4 illustrates a method for obtaining disparities in the disparity generating section 25.

FIG. 4 illustrates a predetermined line on a display surface 30 of the display section 14 displaying an input picture. If a depth of a predetermined pixel 31 in the input picture is one causing the pixel 31 to be displayed so that a viewer feels that the pixel 31 is at a position 32 nearer than the display surface 30, the disparity generating section 25 sets a disparity so that a parallax image (pixel) 31L for a viewpoint 33L is displayed on the right of the pixel 31, and sets a disparity so that a parallax image (pixel) 31R for a viewpoint 33R is displayed on the left of the pixel 31. Furthermore, as is clear from FIG. 4, the disparity generating section 25 sets a larger disparity as the depth is larger.

Also, if a depth of a predetermined pixel 34 in the input picture is one causing the pixel 34 to be displayed so that a viewer feels that the pixel 34 is at a position 35 farther than the display surface 30, the disparity generating section 25 sets a disparity so that a parallax image (pixel) 34L for a viewpoint 36L is displayed on the left of the pixel 31, and sets a disparity so that a parallax image (pixel) 34R for a viewpoint 36R is displayed on the right of the pixel 31. Furthermore, as is clear from FIG. 4, the disparity generating section 25 sets a larger disparity as the depth is larger.

As a result of images for two viewpoints, resulting from shifting the pixel to the left and right based on the disparities generated by the disparity generating section 25, being generated, a two-viewpoint stereoscopic image can be generated. For example, if the viewpoints 33L and 33R are left and right eyes of a viewer, stereoscopic image display causing the viewer to feel that the pixel 31 pops up to the near side can be provided by the pixels 31L and 31R. Similarly, if the viewpoints 36L and 36R are left and right eyes of a viewer, stereoscopic image display causing the viewer to feels that the pixel 34 withdraws to the far side can be provided by the pixels 34L and 34R.

FIGS. 5A to 5C illustrate shifts of images based on disparities obtained in the disparity generating section 25. FIG. 5A illustrates a 2D image, which is an input picture, indicating a state in which an image 42 of two trees is displayed before a background image 41 and an object 43 is further displayed before the two trees 42.

Solid arrows in FIG. 5A indicate movements of the respective images based on disparities for one viewpoint, for example, a left eye. The direction of each arrow indicates the direction of the movement, and the length of each arrow indicates the amount of the movement. In other words, the example in FIG. 5A is one intended to provide an image causing a viewer to feels that the background image 41 is displayed on the far side, the tree image 42 is displayed on the near side and the object 43 is displayed nearest to the viewer with reference to the display surface.

If the images illustrated in FIG. 5A are shifted on a pixel-by-pixel basis according to the arrows, not an ideal parallax image illustrated in FIG. 5B but a parallax image illustrated in FIG. 5C is obtained in reality. In FIG. 5B, a background image 41′, a tree image 42′ and an object 43′ are displayed as a result of the movements of the background image 41, the tree image 42 and the object 43, respectively. However, in reality, as illustrated in FIG. 5C, if the background image 41, the tree image 42 and the object 43 are moved, respectively, an area in which images overlap (part surrounded by a dashed line), and areas 44 and 45 in which no images exist (hidden surface areas), which are indicated by diagonal lines, are generated depending on the movement amounts and direction. The hidden surface area 45 is generated as a result of the movement of the background image 41, and the hidden surface area 44 is generated as a result of the difference in movement amount between the tree image 42 and the object 43.

In order to correct the area in which images overlap and the hidden surface areas, a disparity correcting section 26 is provided. For the area in which images overlap, which is surrounded by the dashed line, the disparity correcting section 26 corrects the disparity so that any one of the images, for example, the nearest (foreground) image is displayed.

In the present embodiment, the disparity correcting section 26 obtains parallax images with suppressed image deterioration for the hidden surface areas, using the disparity of the foreground image.

Hereinafter, for simplification of the description, a distance from an image (pixel) after a movement to the image (pixel) before the movement may be referred to as a “disparity”.

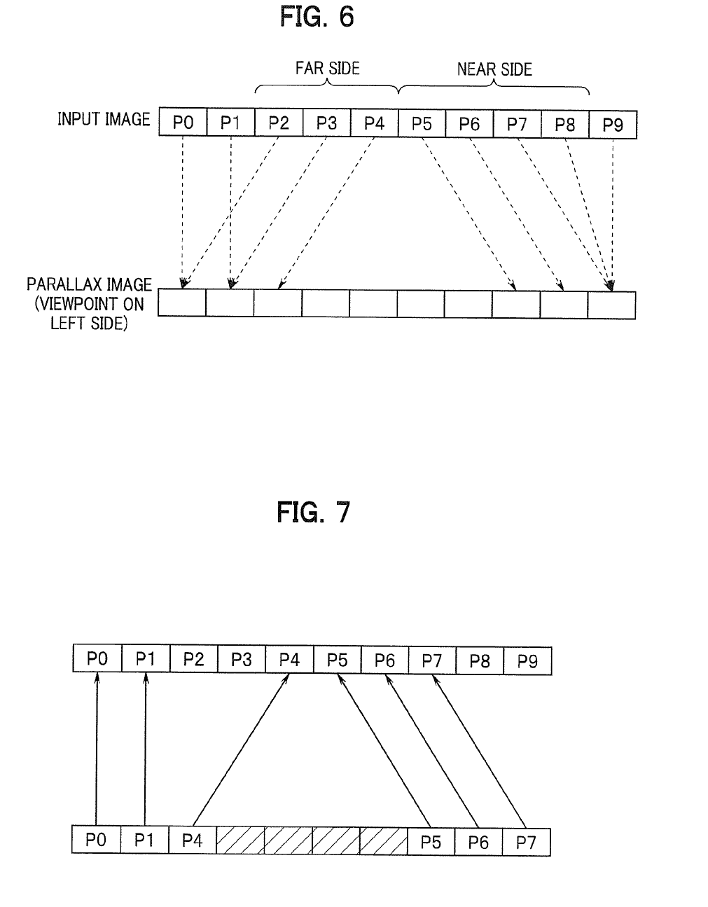

FIGS. 6 to 11 are diagrams illustrating correction performed by the disparity correcting section 26.

FIGS. 6 to 8 and 11 illustrate upper and lower rows indicating a part of a same predetermined line in an image: the upper row indicates pixel positions before a movement and the lower row indicates pixel positions after the movement based on disparities. In FIGS. 6 to 9 and 11, each box indicates, for example, a pixel, and movements of respective pixels according to disparities for one viewpoint, for example, a left eye, are illustrated.

FIGS. 6 to 8 and 11 illustrate a same input image, and from among pixels P0 to P9 in the upper row indicating the input image, display is to be provided so that a viewer feels that pixels P0, P1 and P9 are at positions on the display surface, pixels P2 to P4 are at positions on the far side, and pixels P5 to P8 are at positions on the near side.

In this case, as indicated by dashed arrows in FIG. 6, it can be considered that pixels P0, P1 and P9 remain at the same positions in a horizontal direction, the pixels P2 to P4 are moved to positions on the left side in the horizontal direction, and the pixels P5 to P8 are moved to positions on the right side in the horizontal direction. In other words, each arrow represents a disparity.

FIG. 7 illustrates an image obtained as a result of the movements in the lower row. As described above, the disparity correcting section 26 selects a foreground image for an area in which images (pixels) overlap. Accordingly, the original pixels P0, P1 and P7 are moved so that the pixels P0, P1 and P7 are arranged at the positions of the two pixels from the left and the rightmost pixel in the lower row in FIG. 7 according to the disparities.

The disparity correcting section 26 can determine the foreground image according to the magnitude of the disparity. Where a disparity directed to the right in the screen is represented by a positive value and a disparity directed to the left in the screen is represented by a negative value, from a viewpoint of a left eye, that is, if a viewpoint exists on the left of the viewpoint position of an input image, an image (pixel) having a disparity with a largest positive value can be determined as the foreground image. On the other hand, from a viewpoint of a right eye, that is, if a viewpoint exists on the right of the viewpoint position of an input image, an image (pixel) having a disparity with a largest value in the negative direction is the foreground image.

The disparity correcting section 26 moves the original pixels P4, P5 and P6 so that the pixels P4, P5 and P6 are arranged at the third pixel position from the left and the second and third pixel positions from the right in the lower row in FIG. 7, respectively. The arrows in FIG. 7 indicate a positional relationship with the original pixels. Where the pixels are moved according to the disparities obtained according to the depths alone, the four pixels (shaded portion) in the center of the lower row in FIG. 7 form a hidden surface area.

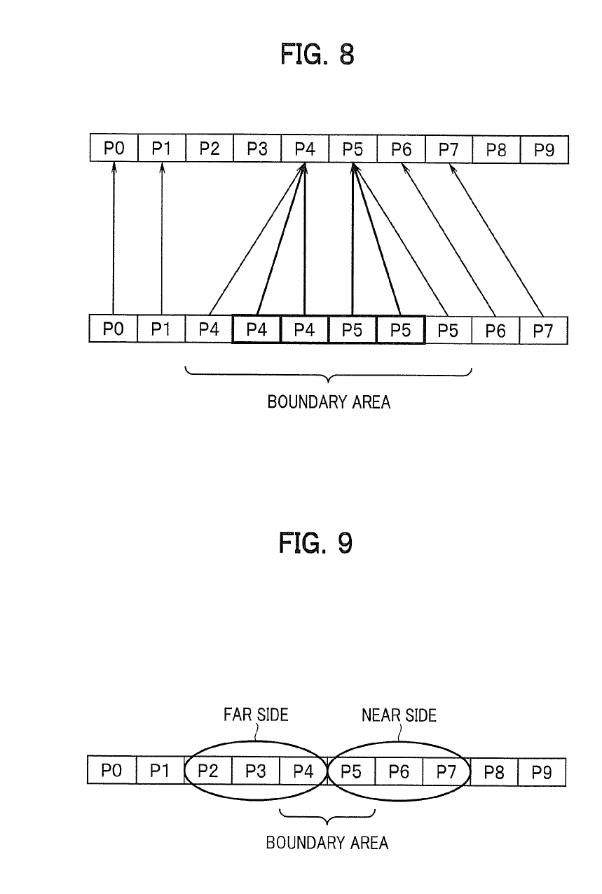

For a technique for interpolating the hidden surface area, a method in which gradual variation is provided using information on pixels neighboring the hidden surface area may be employed. FIG. 8 illustrates such interpolation method. For the pixels in the hidden surface area (the bold box portions), interpolation is performed using neighboring pixels evenly. In the example of the lower row in FIG. 8, the two pixels on the left side of the hidden surface area are interpolated by the pixel P4 adjacent thereto, and the two pixels on the right side are interpolated by the pixel P5 adjacent thereto.

FIG. 9 illustrates the depths of the respective pixels in the input image in the upper row in FIG. 8. As illustrated in FIG. 9, the pixels P2 to P4 form an image to be displayed so that a viewer feels that the image is at a position on the far side relative to the display surface, and the pixels P5 to P7 form an image to be displayed so that the viewer feels that the image is at a position on the near side relative to the display surface. In other words, the pixels P4 and P5 are pixels on a boundary in depth: an object including the pixel P4 and an object including the pixel P5 are different from each other, and it is highly likely that the pixels P4 and P5 are pixels on a boundary between the objects. However, in the example in FIG. 8, three pixels P4 and P5 each, which are the neighboring pixels, are allocated, respectively, providing images whose respective boundary areas are horizontally extended.

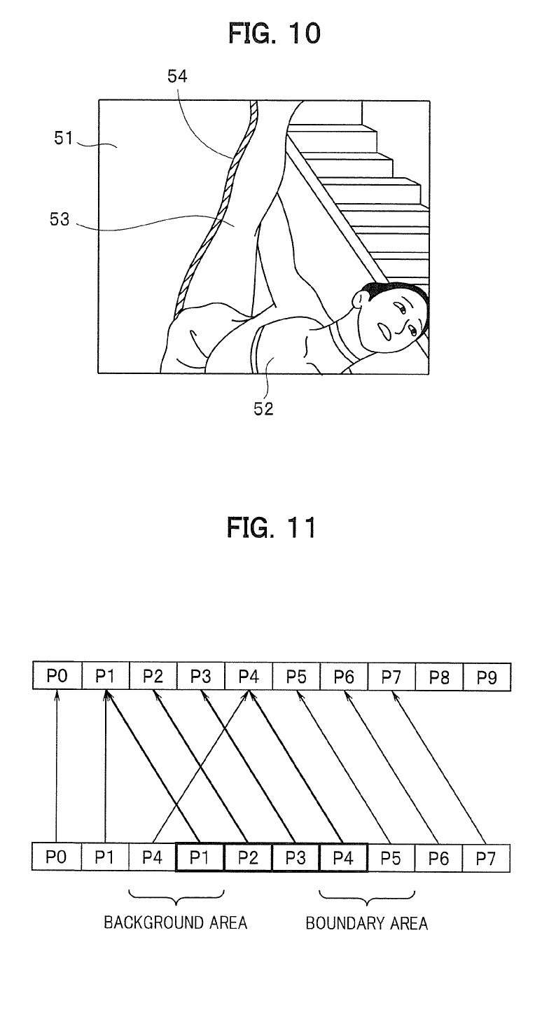

FIG. 10 is a diagram schematically illustrating an example in which a two-viewpoint image for left and right eyes are generated and displayed with a hidden surface area interpolated by the technique in FIG. 8. FIG. 10 indicates that an image 52 of a skating woman is displayed on a background image 51. The boundary portion between an image 53 of a lifted leg of the woman and the background image 51 is horizontally extended, and thus, a blurred image (shaded portion) 54 is displayed.

As described above, a portion in which a front ground and a background are clearly separated in depth, hidden surface areas intensively appear, and images in the hidden surface areas are not favorably generated with the simple filtering processing as in FIG. 8, causing distortion in the boundary portion in depth, that is, the boundary portion between the objects. Where such distortion occurs in a contour of an object, the distortion is highly noticeable on the screen, resulting in quality deterioration of the screen.

Therefore, in the present embodiment, a technique in which a disparity of a foreground image neighboring a hidden surface area is used as a disparity for a hidden surface area is employed.

FIG. 11 is a diagram illustrating disparity correction processing in the present embodiment.

Correction processing for an area in which images overlap is similar that in FIG. 7. In other words, the disparity correcting section 26 moves the original pixels P0, P1 and P7 so that the pixels P0, P1 and P7 are arranged at the pixel positions of the two pixels from the left and the rightmost pixel in the lower row in FIG. 11.

For a hidden surface area indicated by bold boxes, the disparity correcting section 26 uses a disparity of a foremost image neighboring the hidden surface area. In the example in FIG. 11, the pixels P5 to P7 are foreground pixels, and the disparity correcting section 26 determines a disparity of the foreground pixel P5, which is closest to the hidden surface area, as disparities for the hidden surface area. In other words, the inclination of the arrows indicating the disparities for the hidden surface area is made to correspond to the inclination of the arrow for the pixel P5. Accordingly, for the hidden surface area, the original pixels are shifted to the right by the amount of two pixels, providing pixels after movements.

As illustrated in FIG. 11, for the hidden surface area, the original pixels P4, P3, P2 and P1 are moved in this order from the right, providing images after movements. As indicated in the lower row in FIG. 11, the part of the pixels P4 and P5 after movements, which is a boundary part between objects, remains in the state of a boundary similar to that before correction, causing no image quality deterioration.

For a background part, as indicated by the third and fourth pixels from the left in the lower row in FIG. 11, the arrangement order is changed so as to move the original pixels P4 and P1. Accordingly, distortion occurs in this part. However, distortion in a background part is less noticeable compared to distortion in a boundary portion, and thus, the image quality deterioration is relatively small.

The disparity correcting section 26 corrects the disparities from the disparity generating section 25 to those indicated by the arrows in FIG. 11, and outputs the corrected disparities after correction to the image shifting section 27. The image shifting section 27 moves the respective pixels in an input image according to the corrected disparities to generate a parallax image for a respective viewpoint.

Although an example in which a disparity of a foremost pixel from among the pixels on the left and right of a hidden surface area on a same horizontal line are used has been described with reference to FIG. 11, it is possible that: the disparity correcting section 26 sets a predetermined block around pixels to be interpolated in a hidden surface area, detects a foreground pixel in this block, and obtain disparities for the pixels to be interpolated in the hidden surface area from the disparity of the foreground pixel.

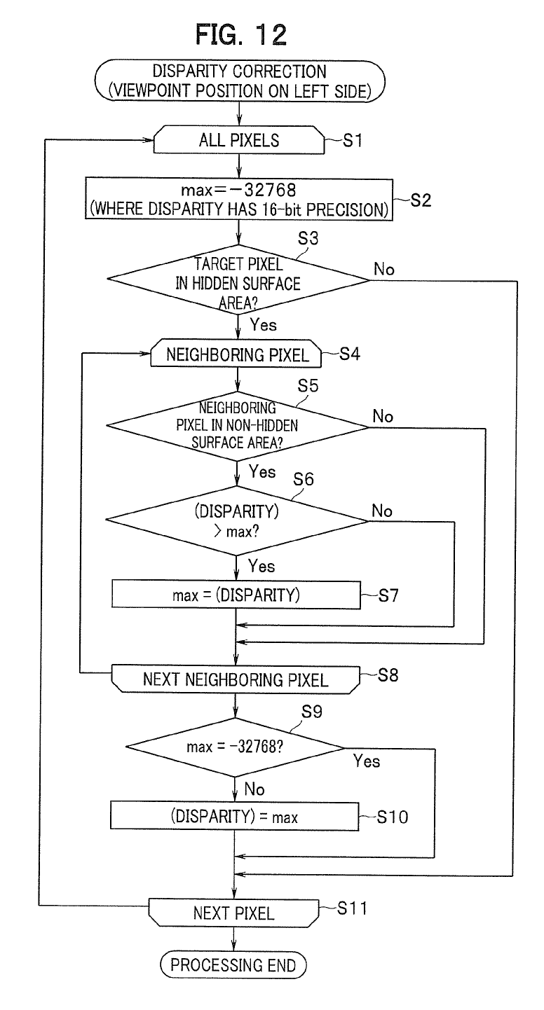

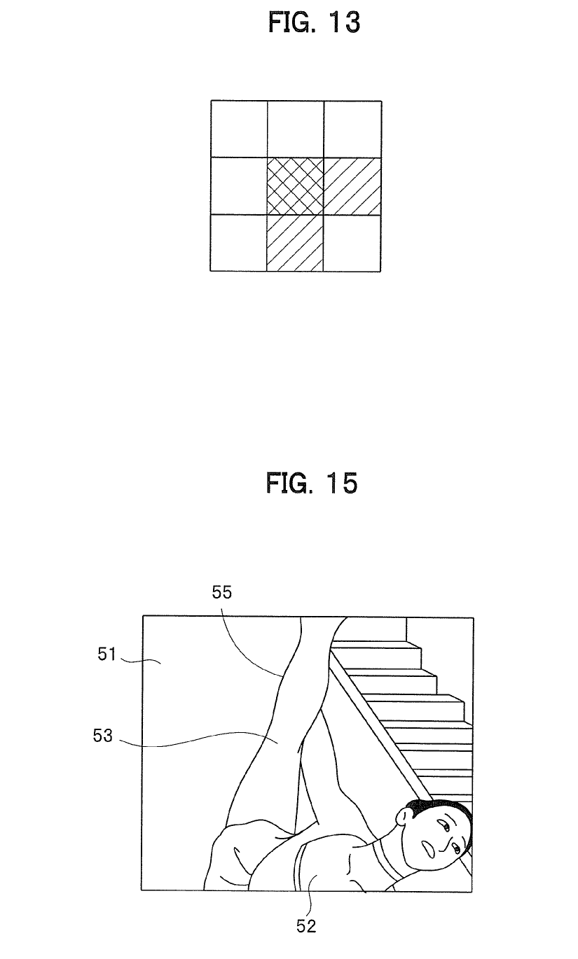

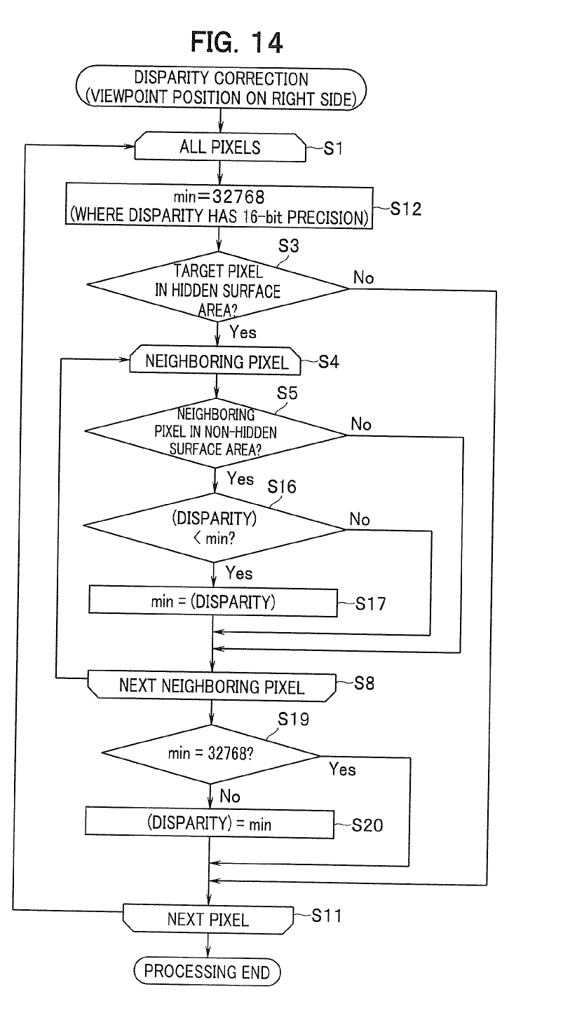

Next, an operation of the embodiment configured as described above will be described with reference to FIGS. 12 to 15. FIGS. 12 and 14 are flowcharts each illustrating an operation of the embodiment, and FIGS. 13 and 15 are diagrams each illustrating an operation of the embodiment.

An input picture and viewpoint information are input to the input terminal 11 of the stereoscopic picture displaying apparatus 10. The depth estimating section 12 obtains a depth of each image in the input picture, for example, on a pixel-by-pixel basis. The input picture, the depths and the viewpoint information are provided to the stereoscopic picture generating section 13. The stereoscopic picture generating section 13 generates parallax images for respective viewpoints by means of the parallax image generating sections 22-1 to 22-n.

In other words, in the parallax image generating section 22, first, disparities for a respective viewpoint are obtained by the disparity generating section 25. The disparity generating section 25 obtains the disparities for the respective viewpoints according to the depth of each pixel. The disparities obtained by the disparity generating section 25 are provided to the disparity correcting section 26.

The disparity correcting section 26 corrects the disparities so that for an area in which images overlap when the images are shifted according to the input disparities, a foreground image from among the overlapping images is selected and displayed. Also, for a hidden surface area in which no image exists when the images are shifted according to the input disparities, the disparity correcting section 26 uses a disparity of the foreground pixel from among the pixels neighboring the hidden surface area.

FIG. 12 illustrates correction processing performed by the disparity correcting section 26 for disparities for a hidden surface area for a viewpoint of a left eye. FIG. 12 illustrates processing that is common to all the viewpoints on the left of the viewpoint position of an input image. In FIG. 12, and FIGS. 14, 16, 17, 19 and 20, which are described later, a disparity directed to the right in the screen is represented by a positive value, and a disparity directed to the left in the screen is represented by a negative value.

The disparity correcting section 26 starts processing for all the pixels in step S1 in FIG. 12. In step S2, the disparity correcting section 26 sets a variable max to −32768, which is a minimum value of a disparity in 16-bit precision. As described above, where the viewpoint is a left eye, a foreground image (pixel) is a pixel with its disparity set to have a largest value in the positive direction. In order to detect the foreground pixel, that is, the pixel with the largest disparity, the disparity correcting section 26 first sets the variable max, to which a disparity is assigned, to the minimum value.

Next, in step S3, the disparity correcting section 26 determines whether or not the target pixel is a pixel in a hidden surface area. If the target pixel is not a pixel in a hidden surface area, the disparity correcting section 26 returns the processing from step S11 to step S1, and performs processing for a next pixel.

If the target pixel is a pixel in a hidden surface area, in the next step S4, the disparity correcting section 26 starts processing for pixels neighboring the target pixel. For example, the disparity correcting section 26 sets a neighboring pixel range, which is indicated in FIG. 13, for the neighboring pixels. The disparity correcting section 26 sets the neighboring pixel range as a range from which a largest disparity is detected. FIG. 13 illustrates an example in which a range of 3×3 pixels is set as the largest disparity detection range. The meshed portion in the center of FIG. 13 indicates the target pixel, the shaded portions indicates a hidden surface area.

In steps S4 to S8, the disparity correcting section 26 searches for a pixel with a largest disparity value in the detection range. In other words, in step S5, the disparity correcting section 26 determines whether or not each neighboring pixel is a pixel in a non-hidden surface area. Since no disparity is set for a pixel in a hidden surface area, the disparity correcting section 26 returns the processing from step S8 to step S4 and performs searching processing for a next neighboring pixel.

If the neighboring pixel is a pixel in a non-hidden surface area, the disparity correcting section 26 determines whether or not a disparity of the pixel is larger than the variable max (step S6), and if the disparity of the pixel is larger than the variable max, the disparity value of the pixel is assigned to the variable max. As a result of the processing being performed for all the pixels in the detection range, the largest disparity value of the pixels in the detection range is assigned to the variable max. As described above, the largest disparity value of the pixels in the non-shaded portion is obtained in the example in FIG. 13.

In step S9, the disparity correcting section 26 determines whether or not the variable max remains in the minimum value of −32768, that is, all the pixels in the detection range, which are neighboring pixels, pixels in a hidden surface area. If the variable max is not the minimum value, the value of the variable max is assigned to a disparity value for the target pixel. As described above, the largest disparity value of the neighboring pixels is obtained as the disparity value for the target pixel. In steps S1 to S11, for every pixel in the hidden surface area, the disparity correcting section 26 obtains a largest disparity value of pixels neighboring the pixel, and determines the largest disparity value as a disparity value for the pixel.

FIG. 14 illustrates correction processing performed by the disparity correcting section 26 for disparities in a hidden surface area for a viewpoint of a right eye. In FIG. 14, steps that are the same as those in FIG. 12 are provided with reference numerals that are the same as those in FIG. 12, and a description thereof will be omitted. FIG. 14 illustrates processing that is common to all the viewpoints on the right of the viewpoint position of an input image.

The case where the viewpoint is a right eye is different from the processing for the viewpoint of the left eye in FIG. 12 in that a pixel with a largest disparity value in the negative direction is a foreground pixel.

Accordingly, the disparity correcting section 26 first sets a variable min for detecting a largest disparity value to a maximum value (step S12). Also, for a pixel in a non-hidden surface area in a detection range, the disparity correcting section 26 determines whether or not a disparity of the pixel is smaller than the variable min (step S16), and if the disparity of the pixel is smaller than the variable min, the disparity value of the pixel is assigned to the variable min. As a result of the processing being performed for all the pixels in the detection range, the largest disparity value in the negative direction of the pixels in the detection range is assigned to the variable min.

In step S19, the disparity correcting section 26 determines whether or not the variable min remains in the maximum value, i. e., 32768, that is, whether or not all the pixels in the detection range, which are neighboring pixels, are pixels in the hidden surface area. If the variable min is not the maximum value, the value of the variable min is assigned to a disparity value for the target pixel. As described above, the largest disparity value in the negative direction of the neighboring pixels is obtained as the disparity value for the target pixel.

The disparity correcting section 26 corrects the disparities of pixels in an area in which images overlap, and based on the flows in FIGS. 12 and 14, corrects the disparities of the pixels in the hidden surface area and outputs the corrected disparities to the image shifting section 27. The image shifting section 27 moves the input images using the corrected disparities to generate a parallax image for a respective viewpoint, and outputs the parallax image.

The stereoscopic picture generating section 13 combines the parallax images generated by the parallax image generating sections 22-1 to 22-n to generate a multi-viewpoint image, and outputs the multi-viewpoint image as a stereoscopic picture via the output terminal 23. The stereoscopic picture is supplied to the display section 14 and displayed on a display screen of the display section 14.

FIG. 15 schematically illustrates display of an image, which is the same as that in FIG. 10, using parallax images generated using disparities corrected by the disparity correcting section 26. As illustrated in FIG. 14, for a disparity for a pixel in a hidden surface area, a value of a foremost pixel from among pixels neighboring the pixel is used, and thus, no distortion occurs in the boundary part 55 between the image 53 of the woman's leg and the background image 51.

As described above, in the present embodiment, for a disparity for a pixel in a hidden surface area, a value of a disparity of a foremost pixel from among pixels neighboring the pixel is used, and thus, distortion of images at a position between objects can be prevented, enabling provision of a high-quality parallax image.

### Second Embodiment

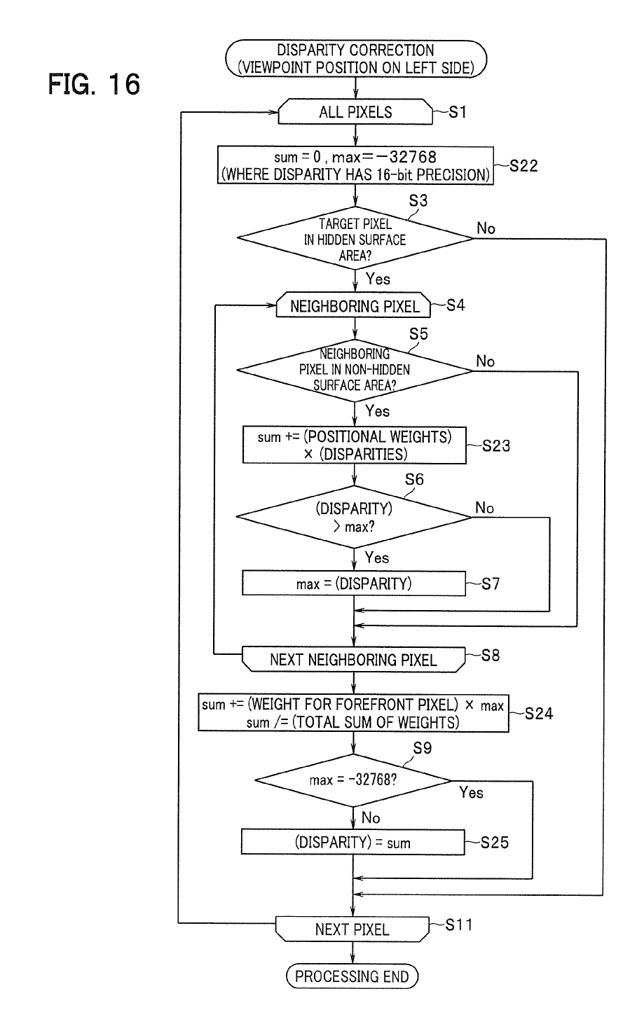

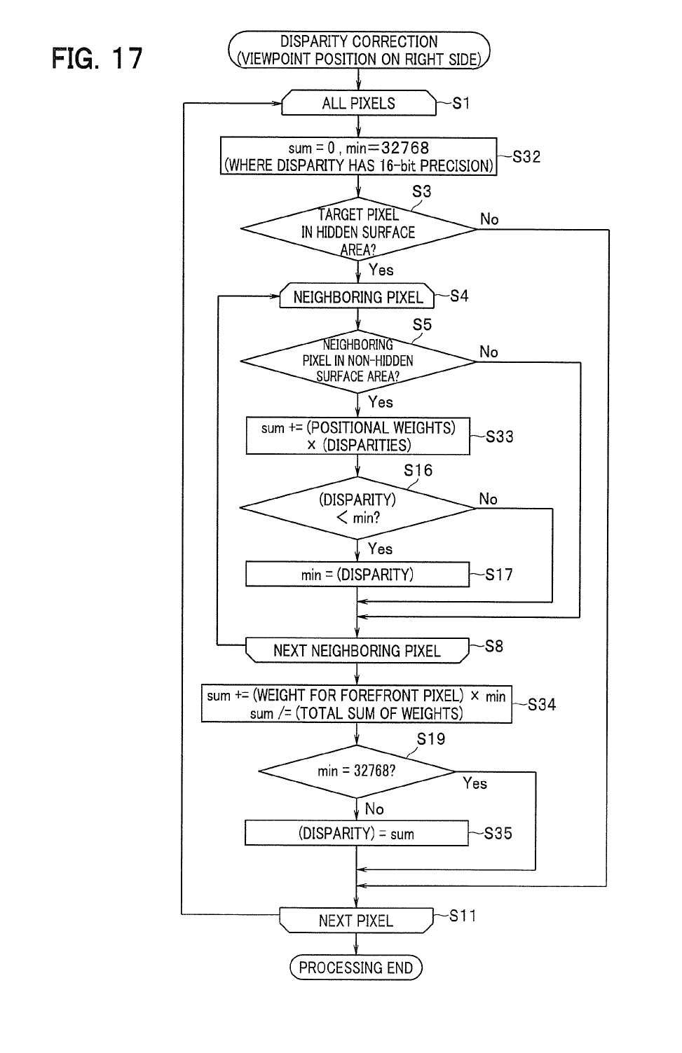

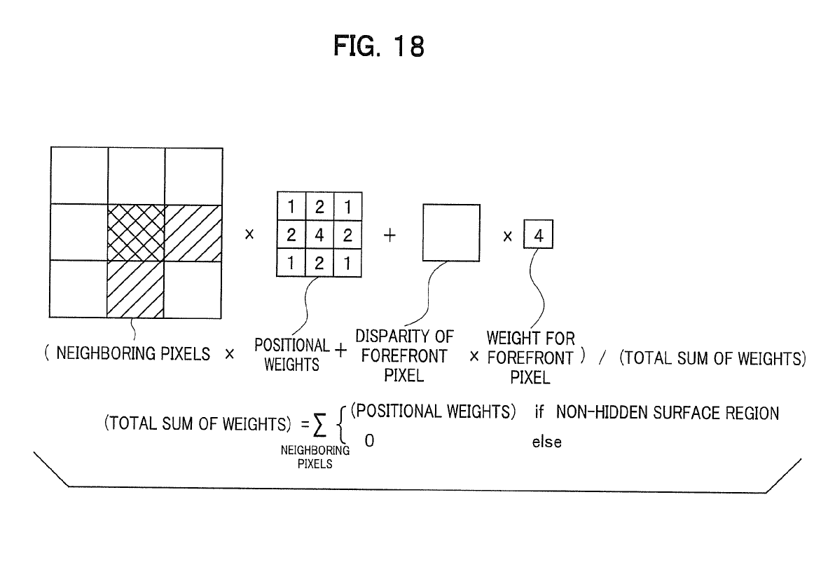

FIGS. 16 to 18 relate to a second embodiment: FIGS. 16 and 17 are flowcharts illustrating the second embodiment, and FIG. 18 is a diagram illustrating the second embodiment.

A hardware configuration in the present embodiment is similar to that in the first embodiment. The present embodiment is different from the first embodiment only in correction processing in the disparity correcting section 26.

First, correction processing for disparities of pixels in a hidden surface area in the second embodiment will be described with reference to FIG. 18. In the first embodiment, a disparity of a foremost image from among images neighboring the image in a hidden surface area is determined as a disparity for a pixel in the hidden surface area. Furthermore, in the present embodiment, a disparity for a pixel in a hidden surface area is obtained using disparities of pixels neighboring the pixel in the hidden surface area as well.

FIG. 18 illustrates a neighboring pixel range set with a target pixel whose disparity is to be corrected in a hidden surface area as its center. FIG. 18 illustrates an example in which a 3×3 pixel range is set as a neighboring pixel range. The meshed portion in the center of FIG. 18 indicates a target pixel, and shaded portions indicate a hidden surface area.

In the present embodiment, the disparity correcting section 26 obtains a disparity for a target pixel by multiplying disparities in the neighboring pixel range by respective set weighting values, further multiplying a disparity of a foreground pixel in the neighboring pixel range with a set weighting value, and adding up both disparities to calculate an average for the disparities.

In the example in FIG. 18, the disparities of the 3×3 neighboring pixels are multiplied by weighting values (positional weights) indicated in the 3×3 frame. A weighting value (4) for the target pixel in the center is indicated for comparison with the neighboring pixels. Furthermore, a disparity of a foreground pixel from among the neighboring pixels is multiplied by the weighting value (4). These multiplication results for a non-hidden surface area are added up, and then divided by a total sum of weighting values (12 in FIG. 18), thereby obtaining the disparity of the target pixel.

In the embodiment configured as described above, correction processing for a hidden surface area, which is illustrated in FIGS. 16 and 17, is performed. In FIGS. 16 and 17, steps that are the same as those in FIGS. 12 and 14 are provided with reference numerals that are the same as those in FIGS. 12 and 14, respectively, and a description of the steps will be omitted.

FIG. 16 illustrates correction processing performed by the disparity correcting section 26 for disparities in a hidden surface area for a viewpoint of a left eye. In step S22 in FIG. 16, the disparity correcting section 26 sets a minimum value for a variable max, and initializes a variable sum to 0. The variable sum is provided to assign a result of weighting and adding up the disparities of the respective neighboring pixels thereto.

In step S23, the disparity correcting section 26 multiplies disparities of neighboring pixels by weights according to the pixel positions (positional weights), and integrates the multiplication results in the value of the variable sum. In steps S4 to S8 and S23, the results of multiplication of the disparity by the positional weight for all the neighboring pixels in the non-hidden surface area are added up. Furthermore, in step S24, the disparity correcting section 26 multiplies a largest disparity value of the neighboring pixels by a weight, adds the multiplication result to the variable sum, and divides the variable sum by a total sum of the weights. The total sum of the weights is also a total sum of the positional weights for the pixels in the non-hidden surface area. In step S25, the disparity correcting section 26 determines the value of the variable sum as a disparity value for the target pixel.

FIG. 17 illustrates correction processing performed by the disparity correcting section 26 for disparities in a hidden surface area for a viewpoint of a right eye. In step S32 in FIG. 17, the disparity correcting section 26 sets a maximum value for a variable min, and initializes a variable sum to 0. In step S33, the disparity correcting section 26 multiplies the disparities of neighboring pixels by weights according to the pixel positions (positional weights), and integrate the multiplication results in the value of the variable sum. As a result of steps S4, S5, S33, S16, S17 and S8, the results of multiplication of the disparity by the positional weight for all the neighboring pixels in the non-hidden surface area are added up.

Furthermore, in step S34, the disparity correcting section 26 multiplies a largest disparity value in the negative direction of the neighboring pixels by a weight, adds the multiplication result to the variable sum, and divides the variable sum by a total sum of the weights. The total sum of the weights also corresponds to a total sum of the positional weights for the pixels in the non-hidden surface area. In step S55, the disparity correcting section 26 determines the value of the variable sum as a disparity value for the target pixel.

The rest of the operation is similar to that in the first embodiment. As described above, in the present embodiment, for a hidden surface area, a disparity for a target pixel is obtained using disparities of pixels neighboring the target pixel and a disparity of a foremost pixel from among the neighboring pixels. Consequently, in the present embodiment, also, image distortion at a boundary position between objects can be prevented, enabling provision of a high-quality parallax image.

In the present embodiment, the disparities of the neighboring pixel and the foreground pixel are weighted and then averaged, which may result in the disparity of the target pixel having a decimal-point precision. In such case, in the image shifting section 27, values of two pixels corresponding to the disparity may be added up depending on the disparity to obtain a pixel value for a parallax image.

### Third Embodiment

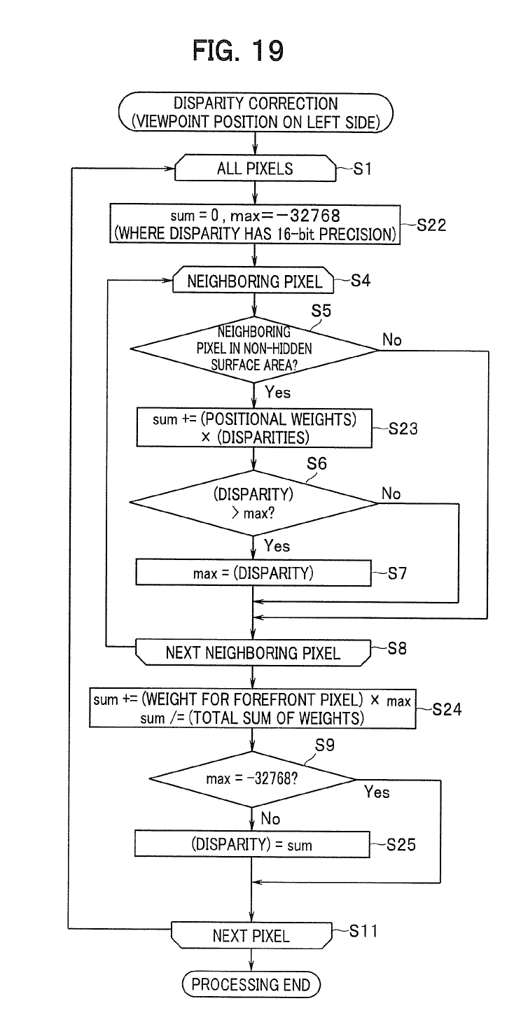

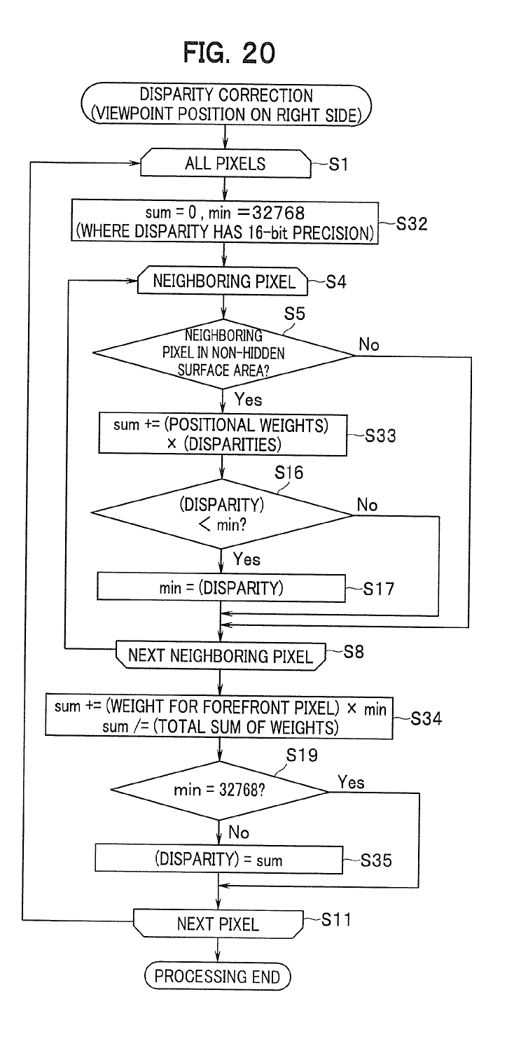

FIGS. 19 and 20 are flowcharts illustrating a third embodiment. In FIGS. 19 and 20, steps that are the same as those in FIGS. 16 and 17 are provided with reference numerals that are the same as those in FIGS. 16 and 17, respectively. A hardware configuration in the present embodiment is similar to those in the first and second embodiments. The present embodiment is different from the second embodiment only in correction processing in a disparity correcting section 26.

In the second embodiment, for each pixel in a hidden surface area, disparities of pixels neighboring the pixel and a foreground pixel from among the neighboring pixels are weighted to obtain a disparity for the target pixel. Meanwhile, in the present embodiment, the correction processing performed for each pixel in a hidden surface area in the second embodiment is performed for all the pixels.

FIG. 19 illustrates correction processing performed by the disparity correcting section 26 for disparities for a viewpoint of a left eye, and FIG. 20 illustrates correction processing performed by the disparity correcting section 26 for disparities for a viewpoint of a right eye.

The flows in FIGS. 19 and 20 are different from the flows in FIGS. 16 and 17 only in that processing in step S3 for limiting target pixels only to pixels in a hidden surface area is omitted.

In the present embodiment, every pixel in an image is a target pixel, a neighboring pixel range with a predetermined size is set around the target pixel, disparities of neighboring pixels and a disparity of a foreground pixel from among the neighboring pixels are weighted to correct a disparity of the target pixel. In this case, possibly, the disparity of the target pixel has already been obtained by a disparity generating section 25 and the disparity of the target pixel is also multiplied by a predetermined weight, for example, as illustrated in the positional weights in FIG. 18.

The rest of operation is similar to that in the second embodiment.

As described above, in the present embodiment, for every pixel, disparities of the neighboring pixels and a disparity of a foreground pixel from among the neighboring pixels are weighted to correct a disparity of the pixel. Consequently, distortion occurring as a result of processing for moving images based on the depths is reduced, enabling provision of a high-quality parallax image.

Furthermore, although the above embodiment has been described in tennis of an example in which correction processing is performed once for a target pixel, the correction processing illustrated in FIG. 18 is repeated a plurality of times for a target pixel, enabling further enhancement of the distortion reduction effect.

As described above, according to the above-described embodiments, images in a hidden surface area can be generated with high precision in processing for conversion into a multi-viewpoint image such as conversion from a one-viewpoint 2D picture to a two-viewpoint stereo 3D picture or conversion from a two-viewpoint stereo 3D picture to a multi-viewpoint 3D picture.

While certain embodiments have been described, these embodiments have been presented by way of example only, and are not intended to limit the scope of the inventions. Indeed, the novel methods and systems described herein may be embodied in a variety of other forms; furthermore, various omissions, substitutions aid changes in the form of the methods ad systems described herein may be made without departing from the spirit of the inventions. The accompanying claims and their equivalents are intended to cover such forms or modifications as would fall within the scope and spirit of the inventions.

What is claimed is:

1. A parallax image generating apparatus comprising:
a disparity generating section configured to receive a depth of each part of an input image, and based on the depth, generate a disparity for each part of the image for a respective viewpoint;
a disparity correcting section configured to correct a disparity of a target part in the image to a value based on a disparity obtained for a foreground part from among parts neighboring the target part; and
an image shifting section configured to move a part of the input image based on the disparity corrected by the disparity correcting section, to generate a parallax image for the respective viewpoint.

2. The parallax image generating apparatus according to claim 1, wherein the disparity correcting section determines a value of the disparity obtained for the foreground part as a value of the disparity of the target part.

3. The parallax image generating apparatus according to claim 1, wherein the disparity correcting section obtains the disparity of the target part using a result of weighting and adding up disparities obtained for the parts neighboring the target part and the disparity obtained for the foreground part.

4. The parallax image generating apparatus according to claim 1, wherein the disparity correcting section obtains the disparity of the target part using a result of weighting and adding up disparities obtained for parts in a predetermined range including the target part and the disparity obtained for the foreground part.

5. The parallax image generating apparatus according to claim 1, wherein the target part is a part of a hidden surface area to which none of the parts of the input image are moved when the image shifting section moves the parts of the input image based on the disparities obtained by the disparity generating section.

6. The parallax image generating apparatus according to claim 2, wherein the target part is a part of a hidden surface area to which none of the parts of the input image are moved when the image shifting section moves the parts of the input image based on the disparities obtained by the disparity generating section.

7. The parallax image generating apparatus according to claim 3, wherein the target part is a part of a hidden surface area to which none of the parts of the input image are moved when the image shifting section moves the parts of the input image based on the disparities obtained by the disparity generating section.

8. The parallax image generating apparatus according to claim 1, wherein the target part is every part in the input image.

9. The parallax image generating apparatus according to claim 2, wherein the target part is every part in the input image.

10. The parallax image generating apparatus according to claim 3, wherein the target part is every part in the input image.

11. The parallax image generating apparatus according to claim 4, wherein the target part is every part in the input image.

12. A stereoscopic picture displaying apparatus comprising:
a depth generating section configured to obtain a depth of each part of an input image;
a parallax image generating section including a disparity generating section configured to, based on the depth, generate a disparity for each part of the image for a respective viewpoint, a disparity correcting section configured to correct a disparity of a target part in the image to a value based on a disparity obtained for a foreground part from among parts neighboring the target part, and an image shifting section configured to move a part of the input image based on a disparity corrected by the disparity correcting section, to generate a parallax image for the respective viewpoint; and
a multi-viewpoint image generating section configured to combine parallax images generated by the parallax image generating section for the respective viewpoints to generate a multi-viewpoint image.

13. The stereoscopic picture displaying apparatus according to claim 12, wherein the disparity correcting section determines a value of the disparity obtained for the foreground part as a value of the disparity of the target part.

14. The stereoscopic picture displaying apparatus according to claim 12, wherein the disparity correcting section obtains the disparity of the target part using a result of weighting and adding up disparities obtained for the parts neighboring the target part and the disparity obtained for the foreground part.

15. The stereoscopic picture displaying apparatus according to claim 12, wherein the disparity correcting section obtains the disparity of the target part using a result of weighting and adding up disparities obtained for parts in a predetermined range including the target part and the disparity obtained for the foreground part.

16. A parallax image generation method comprising:
receiving a depth of each part of an input image, and based on the depth, generating a disparity for each part of the image for a respective viewpoint;
correcting a disparity of a target part in the image to a value based on a disparity obtained for a foreground part from among parts neighboring the target part; and
moving a part of the input image based on the corrected disparity to generate a parallax image for the respective viewpoint.

17. The parallax image generation method according to claim 16, wherein the correcting a disparity includes setting a value of the disparity obtained for the foreground part as a value of the disparity of the target part.

18. The parallax image generation method according to claim 16, wherein the correcting a disparity includes obtaining the disparity of the target part using a result of weighting and adding up disparities obtained for the parts neighboring the target part and the disparity obtained for the foreground part.

19. The parallax image generation method according to claim 16, wherein the correcting a disparity includes obtaining the disparity of the target part using a result of weighting and adding up disparities obtained for parts in a predetermined range including the target part and the disparity obtained for the foreground part.
